(19) United States
(12) Patent Application Publication
(10) Pub. No.: US 2025/0178416 A1
(43) Pub. Date: Jun. 5, 2025

(54) SIDE CRASH BEAM FOR DOOR

(71) Applicant: FCA US LLC, Auburn Hills, MI (US)

(72) Inventors: Hong Gao, Shanghai (CN); Chunmei Fan, Shanghai (CN); Xianozhou Jiang, Shanghai (CN); Fanhui Zhang, Shanghai (CN)

(21) Appl. No.: 18/524,315

(22) Filed: Nov. 30, 2023

(51) Int. Cl. B60J 5/04

(52) U.S. Cl. CPC B60J 5/0444; B60J 5/0447

(57) ABSTRACT

A side crash beam for a vehicle has a first reinforcement beam formed from a sheet material. The first beam spans the door and attaches to an inner panel. A second beam has an elongated cylindrical tube fixed with a plurality of reinforcement members. The second beam spans the door and attaches to the inner panel.

### FIELD

The present disclosure relates to vehicles and, more particularly, to a side crash beam for a vehicle door.

### BACKGROUND

This section provides background information related to the present disclosure which is not necessarily prior art.

Side crash beams have been available on vehicle doors for a number of years. The beam is present to reduce the force of side impacts on the vehicle. Various types of side beams exist for vehicle doors. Ordinarily, the side crash beams are made from a cold stamped or hot formed steel sheet. These beams are connected to the inner door panel by spot welding technology. Due to the high degree of fitting with the outer panel of the door, adhesive coating technology is also used between the side crash beam to adhere the two panels together. This prevents noise and provides shock absorption requirements.

The single beam design has a high material cost since it requires the largest surface area of steel plates. Additionally, the beam requires stamping molds that are also large and costly. Generally, the side crash beam utilizes 7 to 10 spots welds or more to retain it on with the inner panel. Additionally, the sealing cost is high due to the fact that the beam must be sealed along its axis with the outer door panel. Thus, the cost of providing this type of beam is high. While the side beam performs satisfactorily for its intended purpose, designers strive to improve the art.

The present disclosure provides the art with a side crash beam that utilizes an elongated cylindrical steel tube with small end reinforcements that are arc welded with one another. Generally, the steel tube does not directly contact the outer panel. The tube provides significant strength and meets desired strength requirements.

The present disclosure reduces the amount of sealing with the outer panel. Additionally, it provides a simple arc welding to attach the reinforcements to the tube. Thus, the reinforcement is a smaller package and provides significant strength.

### SUMMARY

This section provides a general summary of the disclosure, and is not a comprehensive disclosure of its full scope or all of its features.

According to a first aspect of the disclosure, a side crash beam for a vehicle door comprises a first reinforcement beam formed from a sheet of material. The first beam spans the door and is attached to the inner panel. A second beam includes an elongated cylindrical tube fixed with a plurality of reinforcement members. The second beam spans the door with the reinforcement members attached to the inner panel. The cylindrical tube is arc welded to the reinforcement members. The reinforcement members include an arcuate cradle that receive the cylindrical tube. The first beam is an upper beam, the second beam is a lower beam wherein they are spaced parallel to one another and are generally angled with respect to the horizontal.

According to a second aspect of the disclosure, a vehicle door assembly comprises an inner panel, an outer panel and a side crash beam. The side crash beam includes a first reinforcement beam formed from a sheet material. The first beam spans the door and is attached to the inner panel. A second beam includes an elongated cylinder tube fixed with a plurality of reinforcement members. The second beam spans the door with the reinforcement members attached to the inner panel. The cylindrical tube is arc welded to the reinforcement members. The reinforcement members include an arcuate cradle that receive the cylindrical tube. The first beam is an upper beam, the second beam is a lower beam wherein the beams are spaced parallel to one another and are generally angled with respect to the horizontal.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic plan view of a vehicle door assembly.

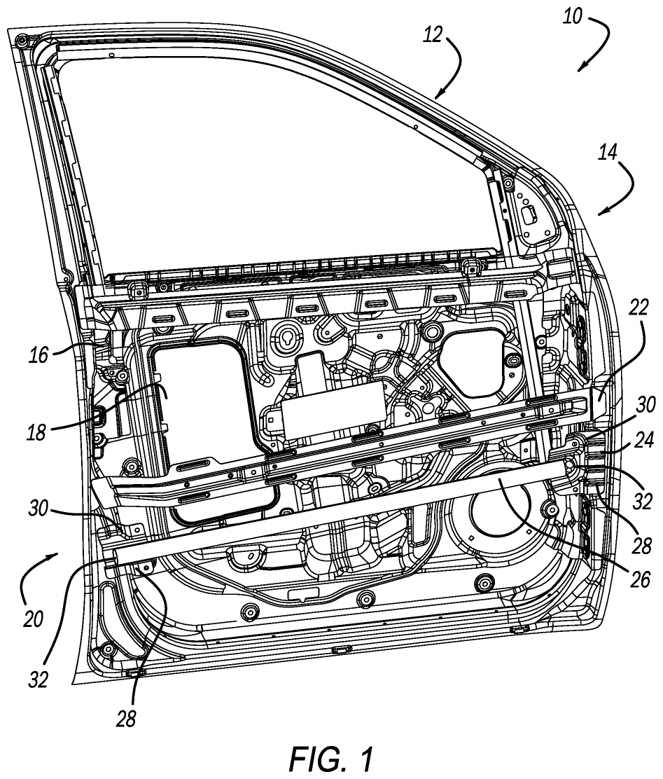

FIG. 2 is an enlarged plan view of a reinforcement member with the tube.

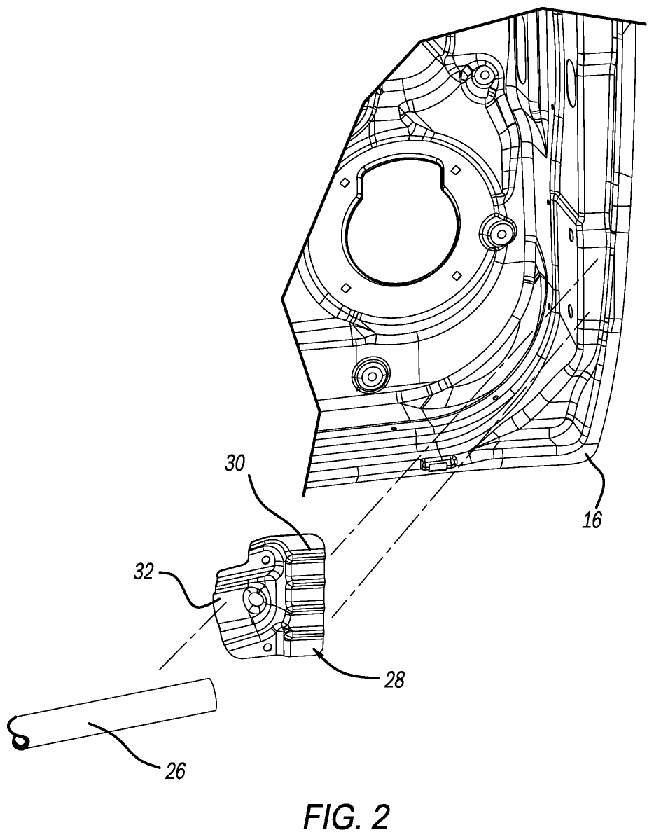

FIG. 3 is a perspective sectional view with the outer panel attached.

Corresponding reference numerals indicate corresponding parts throughout the several views of the drawings.

### DETAILED DESCRIPTION

Example embodiments will now be described more fully with reference to the accompanying drawings.

Turning to the figures, a vehicle door assembly is illustrated and designated with the reference numeral 10. The vehicle door 10 has a window section 12 and a panel section 14. The panel section 14 includes an inner panel 16 having various openings 18 to enable access to inside the door. A crash beam assembly 20 is illustrated secured to the inner panel 16 of the door 10.

The side crash beam assembly 20 includes a first beam 22 and a second beam 24. The first beam 22 is an elongated thin sheet reinforcement beam. Generally, the first beam 22 is stamped from a metallic material. The first beam 22 has a desired height and shape. The second beam 24 includes a cylindrical tube 26 and a pair of reinforcement members 28. The cylindrical tube 26 generally has a right circular cross section. However, any desired configuration would work. The cylindrical tube 26 enables easy manufacturing of the second beam 24. The reinforcement members 28 include an attachment portion 30 and a cradle 32. The attachment portion 30 is secured to the inner panel 16 of the door 10 by spot welding or the like. The tube 26 is positioned into the cradles 32. The tube and reinforcements 28 are arc welded together to provide the second beam 24. The arc welding provides additional strength to the second beam 24.

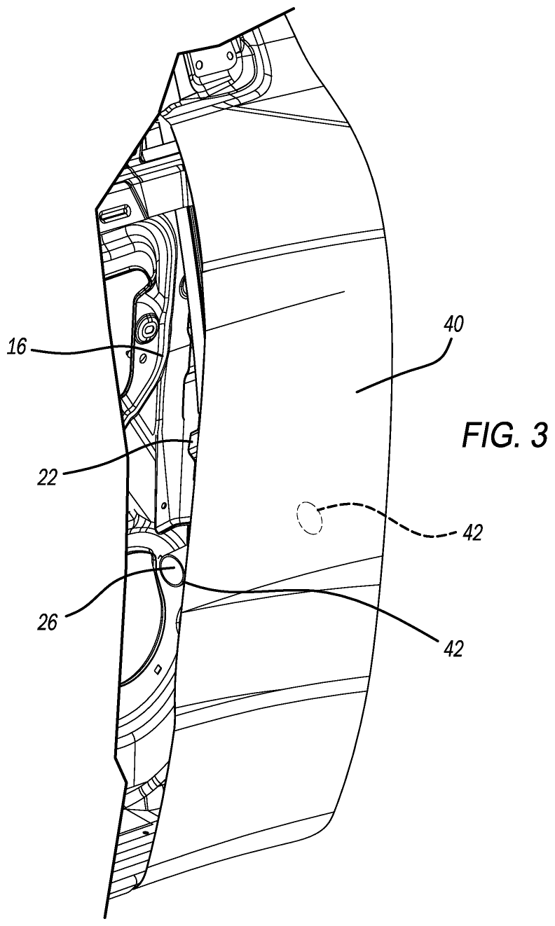

Ordinarily, the tube 26 is sealed with the outer panel 40 as illustrated in FIG. 3. Here, the sealing is generally a spot seal at a desired distance along the tube 26 and the outer panel 40. Ordinarily the seals are equally positioned along the tube 26 to provide noise reduction and shock absorption. Thus, the tube 26 can utilize spot sealants instead of extended seals as in the prior art.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A side crash beam for a vehicle comprising:
a first reinforcement beam formed from a sheet material, the first beam spanning the door for attachment to an inner panel; and
a second beam including an elongated cylindrical tube fixed with a plurality of reinforcement members, the second beam spanning the door for attachment to an inner panel.

2. The side crash beam for a vehicle of claim 1, wherein the cylindrical tube is arc welded to the plurality of reinforcement members.

3. The side crash beam for a vehicle of claim 1, wherein the plurality of reinforcement member includes an arcuate cradle for receiving the cylindrical tube.

4. The side crash beam for a vehicle of claim 1, wherein the first beam is an upper beam on the door.

5. The side crash beam for a vehicle of claim 1, wherein the first and second beam are spaced parallel to one another.

6. The side crash beam for a vehicle of claim 5, wherein the beams are angled with respect to horizontal.

7. A vehicle door assembly comprising:
an inner panel, an outer panel and a side crash beam;
the side crash beam includes a first reinforcement beam formed from a sheet of material, the first beam spanning the door for attachment to the inner panel; and
a second beam including an elongated cylinder tube fixed with a plurality of reinforcement members, the second beam spanning the door and attaching the inner panel.

8. The vehicle door of claim 7, wherein the cylindrical tube is arc welded to the plurality of reinforcement members.

9. The vehicle door of claim 7, wherein the plurality of reinforcement member includes an arcuate cradle for receiving the cylindrical tube.

10. The vehicle door of claim 7, wherein the first beam is an upper beam on the door.

11. The vehicle door of claim 7, wherein the first and second beam are spaced parallel to one another.

12. The vehicle door of claim 11, wherein the beams are angled with respect to horizontal.
